(19) United States
(12) Patent Application Publication
(10) Pub. No.: US 2026/0289225 A1
(43) Pub. Date: Sep. 24, 2026

(54) ELECTROMAGNETIC COUNTER WITH ILLUMINATION DEVICE

(71) Applicant: CONTEX CORPORATION, Tachikawa-shi, Tokyo (JP)

(72) Inventor: Shigeru TSUKAKOSHI, Akishima-shi, Tokyo (JP)

(21) Appl. No.: 19/477,471

(22) PCT Filed: Aug. 11, 2024
(86) PCT No.: PCT/JP2024/028836

§ 371 Date: Oct. 21, 2025

(30) Foreign Application Priority Data
Aug. 13, 2023 (JP) 2023-131733

(51) Int. Cl. G06M 1/10; G06M 1/22

(52) U.S. Cl. CPC G06M 1/102; G06M 1/22

(57) ABSTRACT

An electromagnetic counter with an illumination device includes a board groove in the inner top wall of the inner case that has the number wheel built-in, and a positioning protrusion is provided in the board groove. The board has an illumination device fixed at the tip part and an illumination device electrode is provided at the other end part. The board has a first width part and a second width part that is wider than the first width part formed therein, and a positioning hole is perforated in the first width part. The board is installed in the board groove in such a manner that the positioning hole is fitted to the positioning protrusion. The inner case in which the board is temporarily fixed is inserted into the outer case, so that the board is fixed in a state of being positioned in the inner case.

### RELATED APPLICATIONS

The present application is National Phase of International Application No. PCT/JP2024/028836 filed Aug. 11, 2024, and claims priority from Japanese Application No. 2023-131733, filed Aug. 13, 2023.

### TECHNICAL FIELD

The present invention relates to an electromagnetic counter with an illumination device and more specifically to an illumination device for an electromagnetic counter with an illumination device having a high assembly productivity. While the names with the numerals such as first and second are used in the following explanation, they are for the sake of convenience of explanation, lest it should cause confusion to the same names, and do not influence the interpretation of the right.

### BACKGROUND ART

As a first prior art, there has been known an electromagnetic counter with an illumination device including, in a case, an electromagnet, an anchor rotated by magnetization and demagnetization of the electromagnet, and a number wheel rotating at every predetermined angle with the rotation of the anchor, wherein a flexible board having a light emitting diode for illuminating the number wheel mounted thereon is included in a cavity part inside the case (see Patent Literature 1).

As a second prior art, there has been known an electromagnetic counter with a built-in illumination means having, in a frame member, an electromagnetic counting mechanism including an electromagnet, an anchor rotated by magnetization and demagnetization of the electromagnet, and a plurality of number wheels rotating at every predetermined angle with the rotation of the anchor, the frame member being inserted into a box-shaped cover member to arrange each number wheel in the vicinity of a window provided in front of the cover member to form a display part, so that a count number to be displayed by each number wheel is read through the window, wherein: the electromagnetic counter includes a mounting board, on which a light emitting diode acting as an illumination for the display part is mounted and a wiring pattern for supplying electric power to the light emitting diode is formed; the mounting board is disposed in a narrow small gap formed between an inner side of the cover member and the frame member to locate the light emitting diode in the vicinity of the number wheel; and the electromagnetic counter includes a reflection means at a location around the window on the inner side of the cover member, the reflection means reflecting light from the light emitting diode toward the number wheel (see Patent Literature 2).

### CITATION LIST

### Patent Literature

Patent Literature 1: JP 2005-222143 A
Patent Literature 2: JP 2007-011719 A

### SUMMARY OF INVENTION

### Technical Problem

In the first prior art, a flexible board with a light emitting diode mounted thereon is positioned and then fixed to a case, for example, by means of attachment of a double-sided tape.

Therefore, it is necessary to separately position the flexible board and attach a double-sided tape to it, which may result in low productivity. Furthermore, in case of attaching the flexible board with the double-sided tape, there is a risk that the flexible board may shift depending on the adhesive force.

In the second prior art, the mounting board on which the light emitting diodes are fixed is attached to the case with the double-sided tape, and therefore there exists the same concern as in the first prior art.

The object of the present invention is to provide an electromagnetic counter with an illumination device that can be easily positioned in the case of the board to which the illumination device is attached, and that is unlikely to shift from the position, thereby enhancing productivity.

### Solution to Problem

In order to achieve the above object, a first invention according to the present invention is configured as follows.

An electromagnetic counter with an illumination device, wherein: a cubic inner case is tightly inserted into a cubic outer case having a peephole on the front side, so that they are integrated; the inner case has, in a built-in manner, a number wheel arranged on the front side and an electromagnetic actuator for rotating the number wheel at every predetermined angle; and a board, having an illumination device fixed to one end part and an illumination device electrode for supplying electricity to the illumination device formed at the other end part, is placed at and arranged in the inner case, so that the illumination device is arranged laterally with respect to the number wheel, while an electromagnet electrode and the illumination device electrode are provided by protruding backward from the inner case, characterized in that: the board has a first width part, at least a portion of which is formed with a first width, and a second width part formed more widely than the first width part, while the illumination device is attached to one end part and the illumination device electrode is provided at the other end part; in an inner top wall of the inner case are formed an upper opening part partially opened to face the number wheel, as well as a board groove traversing the upper opening part linearly continuously from the front side to the rear side and formed to have a width for the first width part to fit into the board groove; and the board has the second width part fitted into the upper opening part, while having the first width part fitted into the board groove, and the illumination device is arranged above the number wheel.

In order to achieve the above object, a second invention according to the present invention is configured as follows.

The second invention relates to an electromagnetic counter with an illumination device according to the first invention, characterized in that the board has a positioning hole located in the middle part, the inner case has a positioning protrusion that protrudes from the bottom surface of the board groove, and the positioning protrusion is fitted into the positioning hole.

A third invention according to the present invention is configured as follows.

The third invention relates to an electromagnetic counter with an illumination device according to the second invention, characterized in that the positioning protrusion is a cylindrical part and the positioning hole is a circular hole.

A fourth invention according to the present invention is configured as follows.

The fourth invention relates to an electromagnetic counter with an illumination device according to the third invention, characterized in that the cylindrical part is arranged in the board groove nearer to the side of an inner rear wall than the upper opening part.

A fifth invention according to the present invention is configured as follows.

The fifth invention relates to an electromagnetic counter with an illumination device according to the first or second invention, characterized in that a reflecting plate is arranged between the front surface of the inner case and an outer front wall of the outer case, and a lower plate constituting the reflecting plate is arranged below the number wheel.

### Advantageous Effects of Invention

In the first invention, the electromagnetic counter with an illumination device is configured in such a manner that the cubic inner case is tightly inserted into an outer case that is cube-shaped and has a peephole on the front side.

The inner case has a number wheel arranged on the front side and an electromagnetic actuator for rotating the number wheel at every predetermined angle, which are both built in the inner case.

A board with an illumination device fixed at one end part and an illumination device electrode formed at the other end part, is placed at and arranged in the inner case.

This allows the illumination device to be arranged laterally with respect to the number wheel, while allowing the electromagnet electrode and the illumination device electrode to protrude backward from the inner case.

The board has a first width part, at least a portion of which is formed with a first width, and a second width part formed more widely than the first width part.

The top wall of the inner case forms an upper opening part partially opened to face the number wheel, as well as a board groove traversing the upper opening part linearly continuously from the front side to the rear side and formed to have a width for the first width part to fit into the board groove.

The board is temporarily fixed to the inner case in such a manner that the second width part is fitted into the upper opening part and the first width part is fitted into the board groove. This allows the illumination device to be arranged above the number wheel, with the illumination device electrode protruding backward in the inner case.

By inserting the inner case with the board temporarily fixed into the outer case, the board is held in the board groove by the outer case, thereby completing the electromagnetic counter with the illumination device. The board is fitted into the upper opening part and the board groove, so that it is arranged at a predetermined position with respect to the inner case. Note that “fitted” includes not only a case of being tightly fitted into each other, but also a case where, even if there is a gap, the board can be held in the predetermined position.

Since the second invention has the same configuration as the first invention, the object of the present invention can be achieved. Furthermore, in the second invention, the board has a positioning hole located in the middle part, the inner case has a positioning protrusion that protrudes from the bottom surface of the board groove, and the positioning protrusion is fitted into the positioning hole.

The cylindrical part of the inner case is fitted into the circular hole in the board, which also positions the board relative to the inner case, thereby achieving an advantage of further ensuring the positioning of the board.

Since the third invention has the same configuration as the second invention, the object of the present invention can be achieved. Furthermore, in the third invention, the positioning protrusion is a cylindrical part, and the positioning hole is a circular hole. This makes it easy to fit the cylindrical part into the circular hole, providing the advantage of easy fitting.

Since the fourth invention has the same configuration as the third invention, the object of the present invention can be achieved. Furthermore, in the fourth invention, the cylindrical part is arranged in the board groove nearer to the side of the rear wall than the upper opening part. Therefore, since the arrangement of the illumination device is not affected, this has the advantage of being capable of appropriately illuminating the number wheel.

Since the fifth invention has the same configuration as the first or second invention, the object of the present invention can be achieved. Furthermore, in the fifth invention, since the reflecting plate is also arranged below the number wheel, there is the advantage that the illumination by the illumination device can be further radiated to the number wheel.

### BRIEF DESCRIPTION OF DRAWINGS

FIGS. 1A and 1B are perspective views of the electromagnetic counter with an illumination device according to Example 1 of the present invention, wherein FIG. 1A is an entire perspective view, and FIG. 1B is a perspective view showing a state in which the inner case is pulled out from the outer case.

FIGS. 2A and 2B are perspective views of the inner case of the electromagnetic counter with an illumination device according to Example 1 of the present invention, where FIG. 2A is a back perspective view, and FIG. 2B is a back perspective view showing a state in which the inner case is pulled out from the outer case.

FIG. 3 is a perspective view of the reverse surface of the inner case of the electromagnetic counter with an illumination device according to Example 1 of the present invention.

FIGS. 4A to 4D show the inner case of the electromagnetic counter with an illumination device according to Example 1 of the present invention, where FIG. 4A is a plan view, FIG. 4B is a rear view, FIG. 4C is a left side view, and FIG. 4D is a front view.

FIG. 5 is a cross-sectional view taken along a Y-Y line in FIG. 4A.

FIGS. 6A to 6F show the reflecting plate used in the electromagnetic counter with an illumination device in Example 1 of the present invention, where FIG. 6A is a front view, FIG. 6B is a plan view, FIG. 6C is a left side view, FIG. 6D is a right side view, FIG. 6E is a rear view, and FIG. 6F is a bottom view.

FIGS. 7A to 7F show a board used for the electromagnetic counter with an illumination device according to Example 1 of the present invention, where FIG. 7A is a plan view, FIG. 7B is a front view, FIG. 7C is a left side view, FIG. 7D is a right side view, FIG. 7E is a bottom view, and FIG. 7F is a cross-sectional view taken along the Y-Y line in FIG. 7E.

FIG. 8 is an explanatory view of the electromagnetic counter with an illumination device according to Example 1 of the present invention.

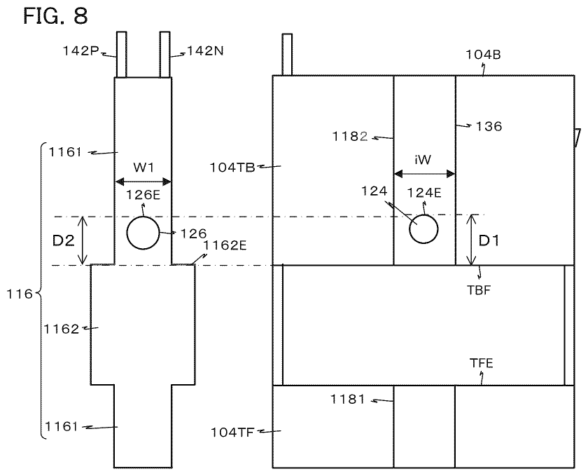

### DESCRIPTION OF EMBODIMENTS

The electromagnetic counter with the illumination device according to the present invention is configured such that the cubic inner case is tightly inserted into the cubic outer case having the peephole on the front side, so that they are integrated; the inner case has, in a built-in manner, the number wheel arranged on the front side and the electromagnetic actuator for rotating the number wheel at every predetermined angle; and the board, having the illumination device fixed to one end part and the illumination device electrode for supplying electricity to the illumination device formed at the other end part, is placed at and arranged in the inner case, so that the illumination device is arranged laterally with respect to the number wheel, while the electromagnet electrode and the illumination device electrode are provided by protruding backward from the side of the reverse surface of the inner case, characterized in that: preferably, the board has a first width part, at least a portion of which is formed with the first width, and a second width part formed more widely than the first width part, while the illumination device is attached to one end part and the illumination device electrode is provided at the other end part; in the top wall of the inner case are formed an upper opening part partially opened to face the number wheel, as well as a board groove traversing the upper opening part linearly continuously from the front side to the rear side and formed to have a width for the first width part to fit into the board groove; and the board has the second width part fitted into the upper opening part, while having the first width part fitted into the board groove, and the illumination device is arranged above the number wheel.

Preferably, the board has a positioning hole located in the middle part, the inner case has a positioning protrusion that protrudes from the bottom surface of the board groove, and the positioning protrusion is fitted into the positioning hole.

Further, preferably, the positioning protrusion is the cylindrical part and the positioning hole is the circular hole.

Further, preferably, the cylinder is arranged in the board groove nearer to the side of a rear wall than the upper opening part.

Further, preferably, the reflecting plate is arranged between the front surface of the inner case and the front plate of the outer case, and a lower plate constituting the reflecting plate is arranged below the number wheel.

### Example 1

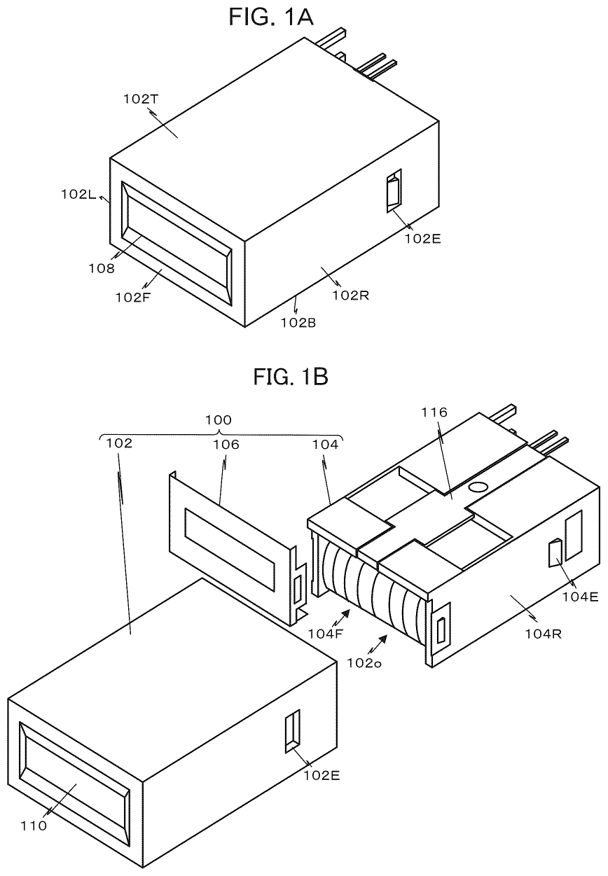

An overview of an electromagnetic counter 100 with an illumination device according to Example 1 of the present invention will be described with reference to FIGS. 1A and 1B.

The electromagnetic counter 100 with the illumination device according to the present invention includes an outer case 102, an inner case 104 and a reflecting plate 106, and is configured such that the reflecting plate 106 is integrated with the front surface of the inner case 104, and the inner case 104 is tightly inserted into the outer case 102.

First, the outer case 102 will be explained mainly with reference to FIGS. 1A and 1B.

The outer case 102 has a function of having the inner case 104 built-in. In Example 1, the outer case 102 is formed to have a hollow cubic shape, is a hexahedron composed of an outer front wall 102F, an outer left wall 102L, an outer right wall 102R, an outer top wall 102T and an outer bottom wall 102B, and a quadrangular storage chamber 102C is formed inside. Meanwhile, the rear side is formed in a quadrangular outer insertion opening 102o. The outer front wall 102F has a rectangular quadrangle. A peephole 108, which is a rectangular opening, is formed in the central part. A peephole cover 110 made of transparent resin is arranged to face the peephole 108. The outer left wall 102L and the outer right wall 102R are rectangular quadrangles and are formed to have the same dimensions. The outer top wall 102T and the outer bottom wall 102B are quadrangles and are formed to have the same dimensions. The outer case 102 is preferably integrally molded from resin, etc.

On the outer right wall 102R, an outer engagement hole 102E is formed to receive and engage with an inner engagement protrusion 104E formed on the inner right wall 104R of the inner case 104. In Example 1, the outer engagement hole 102E is a quadrangle, but it is not limited to this if it has the same engagement function, and may be circular or semicircular.

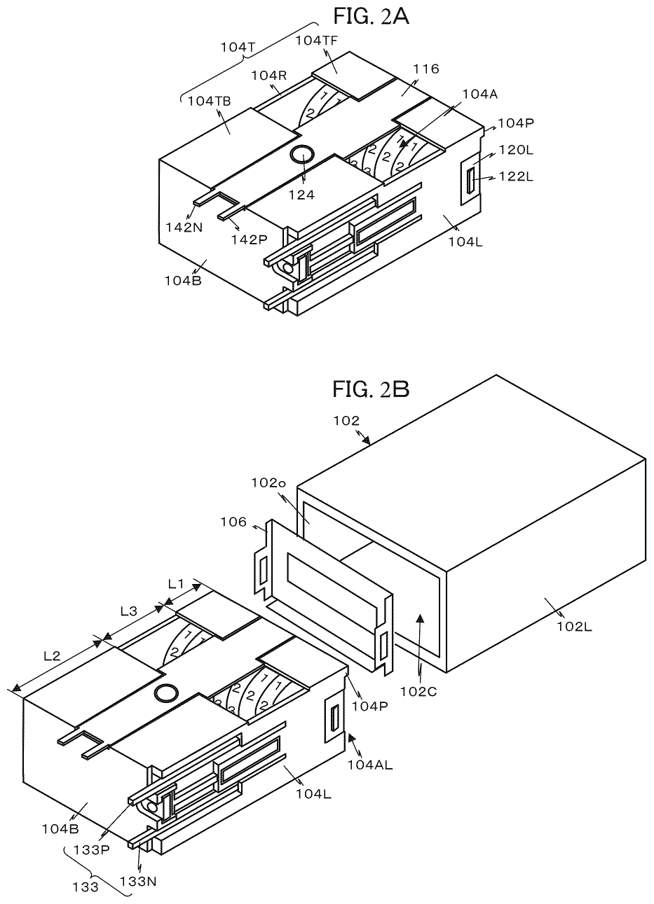

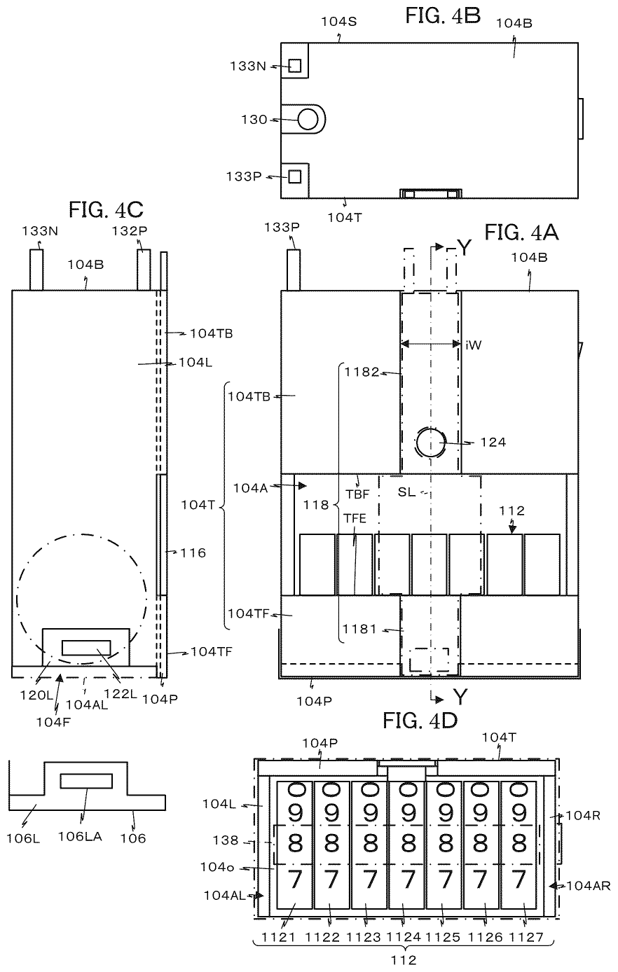

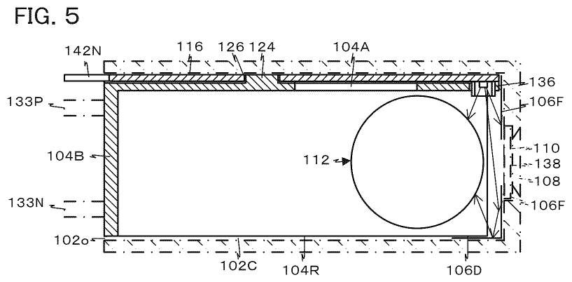

Next, the inner case 104 will be explained mainly with reference to FIGS. 2A to 5.

The inner case 104 has a number wheel 112 and an electromagnetic actuator 114 built-in, has a board 116 attached thereto, and has a function of being fitted into the outer case 102. In Example 1, the inner case 104 has a hollow cubic shape and is a hexahedron composed of an inner front part 104F, an inner left wall 104L, an inner right wall 104R, an inner top wall 104T, an inner lower opening part 104SA, and an inner rear wall 104B. The inner left wall 104L, the inner right wall 104R, the inner top wall 104T, and the inner rear wall 104B are quadrangular flat plates having predetermined thicknesses.

In the inner front part 104F are formed the inner left wall 104L and the inner right wall 104R, which are arranged at a predetermined interval and have predetermined thicknesses, as well as a quadrangular inner front opening 104o formed to have a gate shape by the inner top wall 104T connecting the upper end portions of these walls and enclosed by these walls.

The inner left wall 104L is generally a horizontally elongated quadrangle having a predetermined thickness, but the inner top wall 104T on the side of the inner front opening 104o protrudes more forward than the inner left wall 104L, so that a left-side opening part 104AL is formed underneath. On the outer surface of the front end part of the inner left wall 104L, a left reflecting plate engagement part 122L for engagement of the reflecting plate 106 is formed. A quadrangular and shallow left recessed part 120L, which is formed to have a predetermined length from the tip of the middle of the outer surface of the front tip of the inner left wall 104L, is formed. At the central part of the left recessed part 120L, the left reflecting plate engagement part 122L, having a cross-section formed as a right triangle, is formed.

The inner right wall 104R is a horizontally elongated quadrangle with a predetermined thickness, like the inner left wall 104L, while the inner top wall 104T on the side of the inner front opening 104o protrudes more than the inner right wall 104R, forming a right-side opening part 104AR underneath. A right reflecting plate engagement part 122R for engagement of the right end part of the reflecting plate 106 is formed at the front end part of the inner right wall 104R. A quadrangular and shallow right recessed part 120R is formed in the middle of the outer surface of the front tip of the inner right wall 104R, at a predetermined length from the tip. At the center of the right recessed part 120R, the right reflecting plate engagement part 122R having a cross-section formed as a right triangle is formed to protrude. The quadrangular and shallow right recessed part 120R, which is formed to have a predetermined length from the tip of the middle of the outer surface of the front tip of the inner right wall 104R, is formed. At the center of the right recessed part 120R, the right reflecting plate engagement part 122R having a cross-section formed as a right triangle is formed.

Next, the inner engagement protrusion 104E will be explained.

The inner engagement protrusion 104E is formed in the vicinity of the inner rear wall 104B of the inner right wall 104R. The inner engagement protrusion 104E protrudes into the outer engagement hole 102E formed in the outer right wall 102R and engages with one wall surface forming the outer engagement hole 102E formed on the vertical surface of the outer right wall 102R, thereby having a function of holding the inner case 104 within the outer case 102.

The inner top wall 104T is a quadrangular flat-plate body that connects the upper end portions of the inner right wall 104R and the inner left wall 104L, which are arranged at predetermined intervals. In Example 1, the inner top wall 104T is divided into a front inner top wall 104TF and a rear inner top wall 104TB, with a quadrangular upper opening part 104A formed between them. The front inner top wall 104TF has a quadrangular flat plate shape formed to have a first predetermined length L1 at a top wall convex part 104P continue toward the side of the inner rear wall 104B. The rear inner top wall 104TB has a quadrangular flat plate shape formed to have a second predetermined length L2 from the inner rear wall 104B towards the side of the top wall convex part 104P. The rear end TFE of the front inner top wall 104TF and the front edge TBF of the rear inner top wall 104TB form the quadrangular upper opening part 104A having a third predetermined length L3. The upper opening part 104A is a horizontally elongated quadrangular opening, with the rear part of the number wheel 112 positioned directly below it.

A board groove 118 is formed at the center in the left and right directions of the inner top wall 104T.

The board groove 118 allows the board 116 to fit thereto and has a function of positioning the board 116. In Example 1, the board groove 118 is formed linearly in the front inner top wall 104TF and the rear inner top wall 104TB at the central part in the left and right directions of the inner top wall 104T, and has a width of the board groove width iW. In other words, the board groove 118 is formed such that it traverses the upper opening part 104A continuing linearly from the front side to the rear side. In Example 1, the board groove width iW is approximately 6 mm in width and has a depth of 0.4 mm. In detail, the board groove 118 is composed of a first board groove 1181 formed on the front inner top wall 104TF and a second board groove 1182 formed on the rear inner top wall 104TB, and the upper opening part 104A is arranged between the first board groove 1181 and the second board groove 1182. In other words, the first board groove 1181 and the second board groove 1182 are provided linearly along the same axis SL. In the second board groove 1182, a positioning protrusion 124 is formed.

The positioning protrusion 124 has a function of engaging with a positioning hole 126 formed in the board 116 to position the board 116. In Example 1, the positioning protrusion 124 is a cylindrical protrusion having a predetermined diameter, which protrudes from the bottom surface of the second board groove 1182 in the board groove 118, and may also be as a cylindrical part. When the positioning protrusion 124 fits into the positioning hole 126, this concept includes not only tightly fitting into each other, but also fitting into each other with a small gap. In Example 1, the positioning protrusion 124 is a cylindrical part having a predetermined diameter. As the positioning protrusion 124, other shapes having the same function may be adopted.

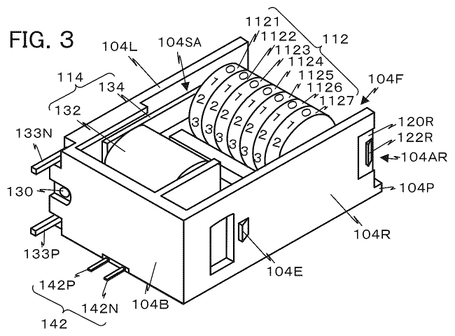

Next, the inner lower opening part 104SA will be explained mainly with reference to FIG. 3.

The inner lower opening part 104SA is an approximately quadrangular opening formed at a position corresponding to the inner bottom wall located facing the inner top wall 104T. In Example 1, the inner lower opening part 104SA is a quadrangular opening in which the approximately entire surface of the lower surface of the inner case 104 is opened.

The inner rear wall 104B connects the rear end portion of the inner left wall 104L and the inner right wall 104R, and has its upper end portion connected to the end part of the inner top wall 104T to be formed as a quadrangular flat-plate shape. In the inner rear wall 104B, a screw hole 130 for a screw for attachment to another device is formed.

Next, the number wheel 112 will be explained mainly with reference to FIG. 3. The number wheel 112 has a function for displaying count values. In Example 1, the number wheel 112 is a disk body having the numbers 0 to 9 displayed at equal intervals on its peripheral surface. On the same shaft is arranged in parallel a plurality of number wheels; specifically, a first-digit number wheel 1121, a second-digit number wheel 1122, a third-digit number wheel 1123, a fourth-digit number wheel 1124, a fifth-digit number wheel 1125, a sixth-digit number wheel 1126, and a seventh-digit number wheel 1127. Thus, in Example 1, a seven-digit count value can be displayed. The first-digit number wheel 1121 is rotated by 36 degrees whenever it is revolved by the electromagnetic actuator 114, so that it is rotated by 360 degrees after 10 actuations. The adjacent second-digit number wheel 1122 is rotated by 36 degrees whenever the first-digit number wheel 1121 completes one rotation. The same also applies to the relationship among the third-digit number wheel 1123 to the seventh-digit number wheel 1127. The number of number wheels constituting the number wheel 112 can be appropriately selected.

While the number wheel 112 is arranged near the inner front opening 104o, approximately the half of the front side is arranged below the front inner top wall 104TF, the rear half of the number wheel 112 faces the upper opening part 104A, and the lower surface of the number wheel 112 faces the inner lower opening part 104SA.

Next, the electromagnetic actuator 114 will be explained.

The electromagnetic actuator 114 has a function of progressing the first-digit number wheel 1121 by every scale with a single excitation. In other words, the electromagnetic actuator 114 has the function of progressing the first-digit number wheel 1121 by every 36 degrees. In Example 1, as the electromagnetic actuator 114, an electromagnetic actuator for a publicly known electromagnetic counter is adopted, and this includes an electromagnet 132 and an anchor 134, etc.

An electromagnetic coil of the electromagnet 132 is magnetized and, for example, a movable piece integrated at the base end of the anchor 134 having, at its tip, a claw part engaging a ratchet gear is attracted to the iron core and the auxiliary iron core to cause the anchor 134 to oscillate around the revolving axis against a spring. Meanwhile, when the current to the electromagnet 132 is interrupted, the magnetic force in the iron core and the auxiliary iron core disappears, and therefore the anchor oscillates in the opposite direction due to the spring force to rotate the first-digit number wheel 1121 by 36 degrees. In other words, the anchor 134 performs one reciprocating oscillating motion by turning on/off the current to the electromagnet 132, and this single oscillating motion causes the ratchet gear to revolve by 36 degrees. The ratchet gear is integrally formed with the first-digit number wheel 1121 and, as the ratchet gear revolves, the first-digit number wheel 1121 is also rotated by 36 degrees. In the electromagnet 132, an electromagnet electrode 133 arranged along the inner left wall 104L protrudes backward from the inner rear wall 104B by a predetermined length. The electromagnet electrode 133 is composed of an electromagnet positive electrode 133P and an electromagnet negative electrode 133N. The electromagnet 132 is supplied with operating electricity through these electromagnet positive electrode 133P and electromagnet negative electrode 133N.

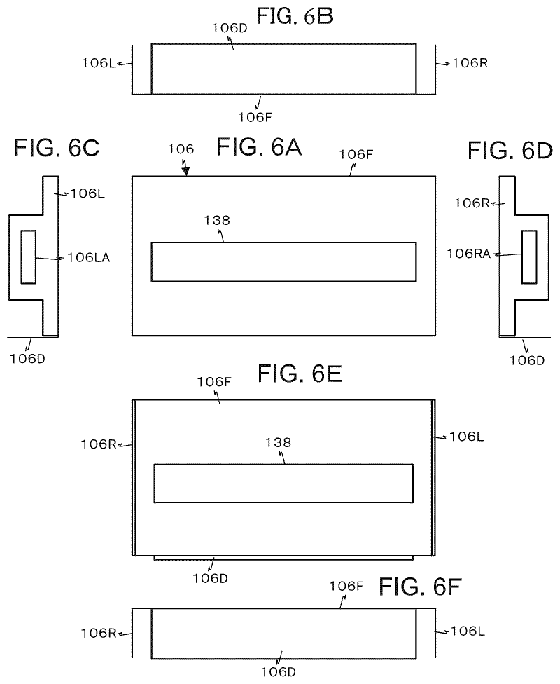

Next, the reflecting plate 106 will be explained mainly with reference to FIGS. 6A to 6F.

The reflecting plate 106 has a function of reflecting light projected from the illumination device 136 mounted on the board 116 toward the number wheel 112. In Example 1, the reflecting plate 106 is composed of a stainless steel sheet metal, but it may be composed of an aluminum sheet metal, a sheet metal with a gloss finish by plating, or resin with a gloss finish by plating, etc. In Example 1, the reflecting plate 106 is configured to have a dustpan shape by a front plate 106F, a left-side plate 106L, a right-side plate 106R and a lower plate 106D, in such a manner that the left-side plate 106L, the right-side plate 106R, and the lower plate 106D are bent at right angles relative to the front plate 106F. In the present specification, the reflecting plate 106 may indicate the entire structure including the front plate 106F, the left-side plate 106L, the right-side plate 106R, and the lower plate 106D, or may indicate any one of the front plate 106F, the left-side plate 106L, the right-side plate 106R, or the lower plate 106D.

First, the front plate 106F will be explained.

The front plate 106F is a horizontally elongated quadrangle as viewed from the front and is arranged to face the inner front part 104F of the inner case 104, with a rectangular reflecting plate translucent hole 138 perforated at the central part. The reflecting plate translucent hole 138 faces the peephole 108 and is formed slightly larger than the peephole 108.

Next, the left-side plate 106L will be explained.

The left-side plate 106L has a function of reflecting light projected from the illumination device 136 at the lateral side of the left-side opening part 104AL formed in front of the inner left wall 104L.

In Example 1, the left-side plate 106L is a flat-plate body having a convex shape when viewed from the front, the flat-plate body being bent at right angles backward from the left end part of the front plate 106F. The left-side plate 106L has a quadrangular reflecting plate left engagement hole 106LA perforated to receive the left reflecting plate engagement part 122L for engagement. The part of the left-side plate 106L adjacent to the front plate 106F faces the left-side opening part 104AL and therefore has a function of reflecting light projected from the illumination device 136.

Next, the right-side plate 106R will be explained.

The right-side plate 106R has a function of reflecting light projected from the illumination device 136 at the lateral side of the right-side opening part 104AR formed in front of the inner right wall 104R.

In Example 1, the right-side plate 106R is a flat-plate body having a convex shape when viewed from the front, which is bent at right angles backward from the right end part of the front plate 106F. The right-side plate 106R has a quadrangular reflecting plate right engagement hole 106RA perforated for receiving and engaging the right reflecting plate engagement part 122R. The part of the right-side plate 106R adjacent to the front plate 106F faces the right-side opening part 104AR and therefore has the function of reflecting light projected from the illumination device 136.

The gap between the left-side plate 106L and the right-side plate 106R is configured to be identical to the lateral width of the inner case 104, in other words, the distance between the outer surfaces of the inner left wall 104L and the inner right wall 104R. Therefore, the left-side plate 106L closely contacts with the left recessed part 120L, and the right-side plate 106R closely contacts with the right recessed part 120R.

Next, the lower plate 106D will be explained.

The lower plate 106D has the function of reflecting the light projected from the illumination device 136 below the lower opening part 104SA formed below the inner front opening 104o.

In Example 1, the lower plate 106D is a flat-plate body having a horizontally elongated quadrangular shape when viewed from the front, which is bent at right angles backward from the lower end part of the front plate 106F. When viewed in plan, the lower plate 106D is arranged such that it overlaps with a part of the number wheel 112 below the number wheel 112. When viewed in plan, the lower plate 106D is formed to have a size that overlaps with approximately one-third of the diameter of the number wheel 112. The lower plate 106D faces the lower opening part 104SA formed below the inner front opening 104o, so that it reflects the light projected from the illumination device 136.

The reflecting plate 106 is temporarily fixed to the inner case 104 in such a manner that the front plate 106F is caused to face the inner front opening 104o, the right-side plate 106R is placed at the inner right wall 104R, the left-side plate 106L is placed at the inner left wall 104L, the reflecting plate left engagement hole 106LA is caused to engage with the left reflecting plate engagement part 122L, and the reflecting plate right engagement hole 106RA is caused to engage with the right reflecting plate engagement part 122R. In other words, the upper end portion of the front plate 106F is placed at the front end face of the top wall convex part 104P.

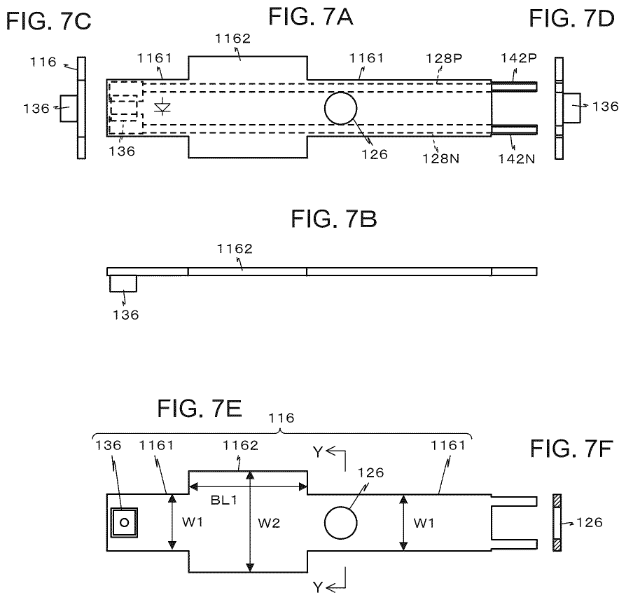

Next, the board 116 will be explained mainly with reference to FIGS. 7A to 7F.

The board 116 has a function of supporting the illumination device 136 and an illumination device electrode 142 for supplying electric power to the illumination device 136, as well as a function of holding the board 116 at a predetermined position relative to the inner case 104. In Example 1, the board 116 has first width parts 1161 of which at least a portion thereof is formed to have first widths W1, and a second width part 1162 formed to have a second width W2 wider than the first width parts 1161, and the illumination device 136 is attached to one end part and the illumination device electrode 142 is provided at the other end part.

In Example 1, the board 116 is formed to have a roughly thinly elongated quadrangular shape as a whole.

Specifically, the board 116 is composed of the first width parts 1161 formed as horizontally elongated quadrangles having the first widths W1, and the second width part 1162 formed to have the second width W2 wider than the first widths W1, between the first width parts 1161. The first widths W1 are formed slightly narrower than the board groove width iW of the board groove 118. The second width part 1162 is arranged at the upper opening part 104A. The second width part 1162 has a predetermined length BL1 in the longitudinal direction of the board 116.

In the board 116, the first width parts 1161 are fitted into the board groove 118 (composed of the first board groove 1181 and the second board groove 1182) and the second width part 1162 is fitted into the upper opening part 104A. When the board 116 is fitted into the board groove 118, the upper surface of the board 116 and the upper surface of the inner top wall 104T are set flush. Fitting the board 116 into the board groove 118 is a concept including not only a case where, when the board 116 is inserted into the board groove 118, the fitting takes place so closely that resistance is sensed, but also a case where, though the insertion resistance is not sensed, the board 116 is hardly moved in the board groove 118 in the width direction.

The board 116 is provided with a printed wire 128 for electrically connecting the illumination device 136 to the illumination device electrode 142. The printed wire 128 is composed of a positive printed wire 128P and a negative printed wire 128N. The positive printed wire 128P is connected to a positive terminal of the illumination device 136 and an illumination device positive electrode 142P, while the negative printed wire 128N is connected to a negative terminal of the illumination device 136 and an illumination device negative electrode 142N.

Next, the positioning hole 126 will be explained.

The positioning hole 126 has a function of positioning, in conjunction with the positioning protrusion 124, the board 116 relative to the inner case 104, and thus positioning the illumination device 136 and the illumination device electrode 142. In Example 1, the positioning hole 126 is a circular hole formed in the first width part 1161 and having a predetermined diameter, and is formed to face the second board groove 1182 formed on the side nearer to the inner rear wall 104B than the second width part 1162. In other words, the positioning hole 126 is provided at the central part of the board 116 in the longitudinal direction. In Example 1, the positioning hole 126 is a circular hole having a predetermined diameter.

Next, the illumination device 136 will be explained.

The illumination device 136 has the function of illuminating the number wheel 112 from above. In Example 1, the illumination device 136 uses a publicly known light emitting diode (LED). In Example 1, the illumination device 136 is formed to have a cuboid shape having a predetermined thickness and is fixed to the lower surface of the front end part of the board 116.

Next, an explanation will be made with reference to the illumination device electrode 142.

The illumination device electrode 142 has a function of connecting the positive printed wire 128P and the negative printed wire 128N, which are connected to the illumination device 136, to the power supply. In Example 1, the illumination device electrode 142 is a pair of thin elongated terminals protruding from one end of the board 116, and includes the illumination device positive electrode 142P and the illumination device negative electrode 142N. The illumination device positive electrode 142P is electrically connected to the positive printed wire 128P, and the illumination device negative electrode 142N is electrically connected to the negative printed wire 128N. Therefore, by inserting the illumination device positive electrode 142P and the illumination device negative electrode 142N into the respective power supply sockets, electric power can be supplied to the illumination device 136 via the positive printed wire 128P and the negative printed wire 128N.

The board 116 is installed in the board groove 118 of the inner case 104. In detail, the first width part 1161 of the board 116 is arranged in the first board groove 1181 and the second board groove 1182 of the board groove 118, the second width part 1162 is arranged in the upper opening part 104A, and the positioning protrusion 124 is caused to engage with the positioning hole 126. In particular, a first distance D1 between the front edge TBF of the rear inner top wall 104TB and a protrusion end surface 124E of the positioning protrusion 124 on the side of the inner rear wall 104B is set slightly larger than a second distance D2 between a board end surface 1162E of the second width part 1162 on the side of the inner rear wall 104B and a hole end surface 126E of the positioning hole 126 on the side of the inner rear wall 104B. As a result, the board end surface 1162E of the board 116 is pressed to contact with the front edge TBF and the protrusion end surface 124E is pressed to contact with the hole end surface 126E, so that, with friction forces between them, the board 116 is held in the inner case 104, concretely, in the board groove 118 with a predetermined friction force. In other words, the board 116 is temporarily fixed to the inner case 104. As the structure where the board end surface 1162E of the board 116 is pressed to contact with the front edge TBF and the hole end surface 126E is pressed to contact with the protrusion end surface 124E, another structure having the same function can be adopted.

Next, a method for assembling the electromagnetic counter 100 with the illumination device will be explained with reference to FIGS. 1A to 2B.

When manufacturing the electromagnetic counter 100 with the illumination device, the outer case 102, the inner case 104 having the number wheel 112 and the electromagnetic actuator 114 built-in, and the board 116 are prepared.

First, the board 116 is set into the board groove 118. Namely, the board 116 is temporarily fixed to the inner case 104 by fitting the positioning hole 126 to the positioning protrusion 124. As a result, the first width part 1161 is fitted into the first board groove 1181 and the second board groove 1182, and the second width part 1162 is fitted into the upper opening part 104A. The first distance D1 between the front edge TBF and the protrusion end surface 124E of the positioning protrusion 124 is set slightly larger than the second distance D2 between the board end surface 1162E and the hole end surface 126E of the positioning hole 126 on the side of the inner rear wall 104B. As a result, the board end surface 1162E and the front edge TBF as well as the protrusion end surface 124E and the hole end surface 126E come into contact with a predetermined pressure contact force, so that, if there is a predetermined friction force and no external force acts, the board 116 is held in the inner case 104 and does not shift. As a result, the illumination device 136 is arranged above the central part of the number wheel 112, and the illumination device electrode 142 protrudes backward at a predetermined position of the inner rear wall 104B.

Next, the reflecting plate 106 is fitted to the inner case 104. Namely, the front plate 106F of the reflecting plate 106 is caused to face the inner front part 104F of the inner case 104, the left-side plate 106L is placed at the outer surface of the inner left wall 104L, and the right-side plate 106R is placed at the outer surface of the inner right wall 104R, which are then pushed in. As a result, the left-side plate 106L fits into the left recessed part 120L, the left reflecting plate engagement part 122L protrudes from the reflecting plate left engagement hole 106LA, and the left-side plate 106L is caused to engage with the left reflecting plate engagement part 122L. The right-side plate 106R fits into the right recessed part 120R, and the right reflecting plate engagement part 122R protrudes from the reflecting plate right engagement hole 106RA, so that the right-side plate 106R engages with the right reflecting plate engagement part 122R. As a result, in a state where the left-side plate 106L faces the left-side opening part 104AL, the right-side plate 106R faces the right-side opening part 104AR, and the lower plate 106D faces the inner lower opening part 104SA, the reflecting plate 106 is temporarily fixed to the inner case 104. Each of the left-side plate 106L, the right-side plate 106R, and the lower plate 106D can reflect the light projected from the illumination device 136 toward the number wheel 112.

Next, the inner case 104 to which the board 116 and the reflecting plate 106 are temporarily fixed is inserted into a storage chamber 102C through the outer insertion opening 102o. The inner engagement protrusion 104E is made to protrude from the outer engagement hole 102E of the outer case 102, and the outer case 102 is caused to engage with the inner engagement protrusion 104E, so that the assembly is completed. As a result, the reflecting plate 106 and the board 116 are sandwiched and fixed between the inner case 104 and the outer case 102.

The present invention is not limited to the above-described embodiments, and it is needless to say that various modifications may be made within the scope of the present invention as far as it does not deviate from the essence of the present invention.

### REFERENCE SIGNS LIST

100 Electromagnetic counter with an illumination device
102 Outer case
102F Outer front wall
104 Inner case
104A Upper opening part
104B Inner rear wall
106 Reflecting plate
106D Lower plate
108 Peephole
112 Number wheel
114 Electromagnetic actuator
116 Board
1161 First width part
1162 Second width part
118 Board groove
1181 First board groove
1182 Second board groove
124 Positioning protrusion
126 Positioning hole
133 Electromagnet electrode
136 Illumination device
142 Illumination device electrode

1. An electromagnetic counter with an illumination device, wherein
a cubic inner case is tightly inserted into a cubic outer case having a peephole on the front side, so that they are integrated,
the inner case has, in a built-in manner, a number wheel arranged on the front side and an electromagnetic actuator for rotating the number wheel at every predetermined angle, and
a board, which has an illumination device fixed to one end part and an illumination device electrode for supplying electricity to the illumination device formed at the other end part, is placed at and arranged in the inner case, so that the illumination device is arranged laterally with respect to the number wheel, while an electromagnet electrode and the illumination device electrode are provided by protruding backward from the inner case, characterized in that
the board has a first width part, at least a portion of which is formed with a first width, and a second width part formed more widely than the first width part, while the illumination device is attached to one end part and the illumination device electrode is provided at the other end part,
in an inner top wall of the inner case are formed an upper opening part partially opened to face the number wheel, as well as a board groove traversing the upper opening part linearly continuously from the front side to the rear side and formed to have a width for the first width part to fit into the board groove, and
the board has the second width part fitted into the upper opening part, while having the first width part fitted into the board groove, and the illumination device is arranged above the number wheel.

2. The electromagnetic counter with the illumination device according to claim 1, wherein
the board has a positioning hole located in the middle part,
the inner case has a positioning protrusion that protrudes from the bottom surface of the board groove, and
the positioning protrusion is fitted into the positioning hole.

3. The electromagnetic counter with the illumination device according to claim 2, wherein
the positioning protrusion is a cylindrical part and
the positioning hole is a circular hole.

4. The electromagnetic counter with the illumination device according to claim 3, wherein
the cylindrical part is arranged in the board groove nearer to the side of an inner rear wall than the upper opening part.

5. The electromagnetic counter with the illumination device according to claim 1, wherein
a reflecting plate is arranged between the front surface of the inner case and an outer front wall of the outer case, and a lower plate constituting the reflecting plate is arranged below the number wheel.
